(19) United States
(12) Patent Application Publication
(10) Pub. No.: US 2007/0178949 A1
(43) Pub. Date: Aug. 2, 2007

(54) Mobile Terminal

(75) Inventors: Takafumi Sato, Hokkaido (JP); Shiro Arita, Hokkaido (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/460,196

(22) Filed: Jul. 26, 2006

(30) Foreign Application Priority Data
Jul. 28, 2005 (JP) 2005-219360
Sep. 29, 2005 (JP) 2005-284899

(51) Int. Cl. H04M 1/00

(52) U.S. Cl. 455/575.3

(57) ABSTRACT

A mobile terminal able to emit an information sound outwardly even in a case where it is set down in a closed state, in particular a mobile phone including a first housing having a projecting part at one end and having a second housing having a recess in which the projecting part is fitted on one end and having a built-in information speaker, the projecting part being pivotably connected to the inside of the recess so as to enable the first housing and the sender housing to be opened and closed, wherein a top surface of the projecting part is located at an inside from the plane including a back surface of the sender housing on an opposite side to a facing surface in the closed state of the mobile phone, a space is provided between the projecting part and the recess, and sound emission ports for emitting sound from the information speaker are provided in a wall surface of the recess forming that space.

### CROSS REFERENCE TO RELATED APPLICATION

The present invention contains subject matter related to Japanese Patent Application No. 2005-219360 filed in the Japan Patent Office on Jul. 28, 2005, and Japanese Patent Application No. 2005-284899 filed in the Japan Patent Office on Sep. 29, 2005, the entire contents of which being incorporated herein by reference.

### BACKGROUND OF THE INVENTION

1. Field of the Invention

The present invention relates to a mobile terminal such as a mobile phone, a personal digital assistant (PDA), a digital camera, and so on.

2. Description of the Related Art

Conventionally, in mobile terminals such as mobile phones, PDAs, digital cameras, and so on, clamshell type devices have become the mainstream. This type of mobile terminal can be folded up to make it more compact, therefore is advantageous for carrying. Further, it may be opened up to secure a sufficient size. At the same time, in a mobile phone, the speaker and microphone can be brought close to a user's ear and mouth.

A mobile terminal has an information speaker for informing the user of an incoming call or an erroneous operation. In a terminal capable of being superposed the two parts of the housing in the closed state such as a clamshell type, usually a sound emission port of the information speaker is provided in a surface (back surface) opposite to the surfaces of the housing facing each other in the closed state (Japanese Patent Publication (A) No. 2004-254026).

However, various problems are caused by providing a sound emission port in the back surface of the housing.

For example, when placing the mobile terminal on a desk, the back surface abutted against the desk top and thereby ended up blocking the sound emission port of the information speaker, so the user was liable to be unaware of an incoming call when he or she left the immediate vicinity of the mobile terminal.

In the opened state, when sounds are emitted from the sound emission port in the back surface, the sounds are emitted toward the opposite side to the user, so transmission efficiency of the sound to the user lowers.

### SUMMARY OF THE INVENTION

An object of the present invention is to provide a clamshell type mobile terminal enabling an information sound to be emitted efficiently.

According to a first aspect of the present invention, there is provided a mobile terminal comprising a first housing having a projecting part on one end and a second housing having a recess in which the projecting part is fitted at one end and having a built-in speaker, the projecting part being pivotably connected in the recess so as to enable the first housing and the second housing to be opened and closed, wherein a top surface of the projecting part is located at an inside from a plane including a back surface at an opposite side to a facing surface of the second housing in the closed state of the mobile terminal, there is a space between the projecting part and the recess, and a first sound emission port for emitting sound from the speaker is provided in a wall surface of the recess forming the space.

Preferably, the back surface of the second housing is provided with a second sound emission port for emitting sound from the speaker.

Preferably, the second housing is provided with a battery, substantially the entire back surface of the second housing is formed by a lid for the battery, and the second sound emission port is formed in the lid.

Preferably, the second housing is provided with a sound conduction space for conducting the sound from the speaker to the first and second sound emission ports, the sound conduction space has a first space formed by a back plate forming the back surface of the second housing and a first surface separated from the back plate by a first distance and a second space formed by the back plate and a second surface separated from the back plate by a distance longer than the first distance, the first sound emission port is connected with the second space, and the second sound emission port is connected with the first space.

Preferably, the speaker has a speaker surface facing the back plate in the first space.

Preferably, a rotation limiter for restricting further rotation to an opening direction by engagement with the back surface of the second housing in the opened state is provided on the first housing at a base side of the projecting part, the space between the recess and the projecting part opens to the facing surface side and the back surface side is shut by the rotation limiter in the opened state of the mobile terminal.

According to a second aspect of the present invention, A mobile terminal includes a first housing having a projecting part on one end and a second housing having a recess in which the projecting part is fitted at one end and having a built-in speaker, wherein the projecting part being pivotably connected in the recess so as to enable the first housing and the second housing to be opened and closed, there is a space between the projecting part and the recess, and a first sound emission port for emitting sound from the speaker is provided in a wall portion of the recess.

Preferably, an opening part connected the space is provided at a top side of the projecting part in the closed state where the first housing and the second housing are superposed on each other, an opening part connected the space is provided at the top side of the projecting part side in the opened state where the first housing and the second housing do not face each other.

Preferably, an external shape of the projecting part in a section perpendicular to an axis of rotation includes semicircle.

Preferably, a second sound emission port for emitting sound from the speaker is provided in the second housing at a back surface opposite to a surface facing the first housing in the closed state where the first housing and the second housing are superposed on each other.

Preferably, the second sound emission port faces a speaker surface of the speaker.

Preferably, a stopper is provided on at least one of the first housing and the second housing. The stopper restricts rotation in the opened state by touching the other of the first housing and the second housing and shut a one end of the space.

According to the present invention, a clamshell type mobile terminal can emit the information sound efficiently.

### BRIEF DESCRIPTION OF THE DRAWINGS

These and other objects and features of the present invention will become clearer from the following description of the preferred embodiments given with reference to the attached drawings, wherein:

FIG. 1 is a perspective view of the appearance of a mobile phone according to an embodiment of the present invention in an opened state;

FIGS. 2A and 2B are perspective views of the appearance of the mobile phone of FIG. 1 in a closed state;

FIG. 3 is a partially cutaway perspective view of a hinge part of the mobile phone of FIG. 1;

FIG. 4 is a sectional view of part of a second housing of the mobile phone of FIG. 1;

FIG. 5 is a perspective view of a back cover of the second housing of the mobile phone of FIG. 1;

FIG. 6 is a sectional view of a sound path of an information speaker in the closed state of the mobile phone of FIG. 1; and

FIG. 7 is a sectional view of a sound path of the information speaker in the opened state of the mobile phone of FIG. 1.

FIGS. 8A and 8B are perspective views of the appearance of a mobile phone according to a modification of the present invention.

FIG. 9 is an enlarged view of hinge part of the mobile phone of FIG. 8A.

FIG. 10 is a disassembled perspective view of the second housing of the mobile phone of FIG. 8A.

FIG. 11 is a sectional view showing a sound path of the information speaker in the closed state of the mobile phone of FIG. BA.

FIG. 12 is a sectional view showing a sound path of the information speaker in the opened state of the mobile phone of FIG. 8A.

### DESCRIPTION OF THE PREFERRED EMBODIMENTS

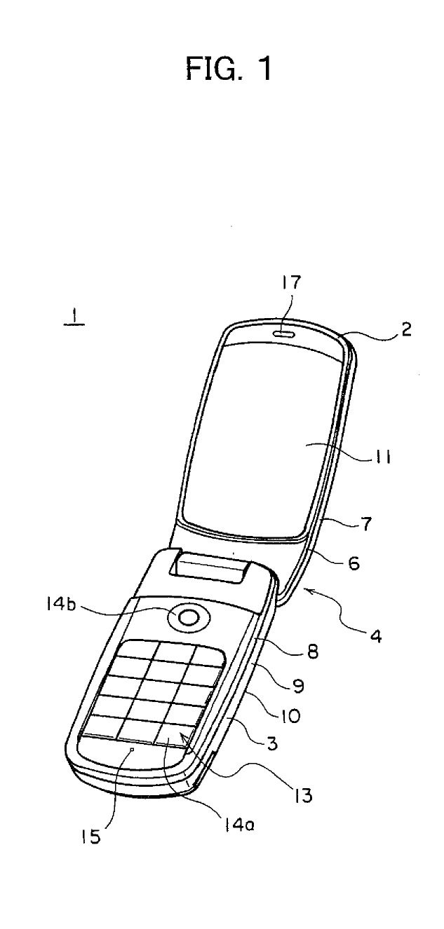

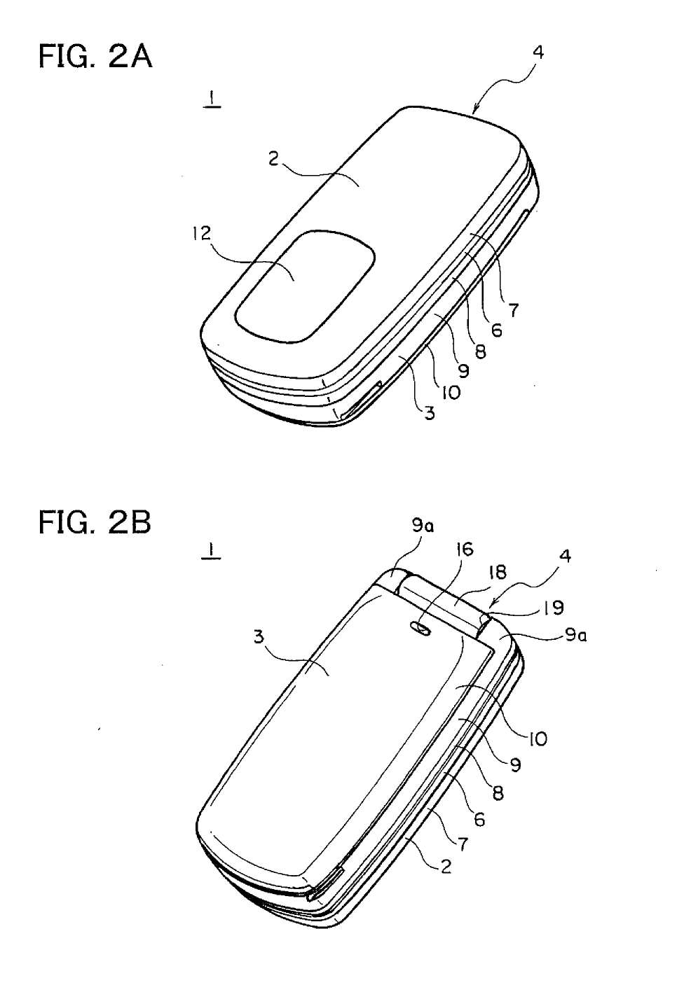

FIG. 1 and FIGS. 2A and 2B are perspective views of the appearance of a mobile phone 1 according to an embodiment of the present invention. The mobile phone 1 is constituted as a so-called clamshell type mobile phone. FIG. 1 shows an opened state, and FIG. 2A and FIG. 2B show a closed state.

The mobile phone 1 is provided with a first housing 2 and a second housing 3. The first housing 2 and the second housing 3 are connected at their ends by a hinge part 4. The mobile phone 1 can open and close about the hinge part 4. The first housing 2 and the second housing 3 are formed as generally thin box shapes which are superimposed on each other in the closed state. They substantially match in contour when viewing one housing side from the other housing side.

The first housing 2 is provided with a front case 6 in the front side that the surface (front surface) facing the second housing 3 in the closed state and a back case 7 in the back side. The front case 6 and the back case 7 are for example molded from plastic. The first housing 2 is provided with a main display 11 for displaying images on the front surface and a sub display 12 for displaying images on the back surface. The main display 11 and the sub display 12 are formed by for example liquid crystal displays. Note that the first housing 2 is also provided with a speech speaker. A sound emission port 17 of the speaker is provided in the front case 6.

The second housing 3 is provided with a front case 8 in the front side that the surface facing the first housing 2 in the closed state, a back case 9 in the back side, and a lid (back plate) 10 on the back surface of the back case 9. The front case 8, the back case 9, and the lid 10 are for example molded from plastic. The second housing 3 is provided with a input section 13 for receiving operations by the user, an antenna, a circuit board having an IC chip and electronic parts mounted thereon, a battery 26, a speech use microphone, and an information speaker 25. The input section 13 includes for example dial buttons 14a, a cursor key 14b, and various other types of buttons exposed from the front case 8. A sound collection port 15 for the speech use microphone (not shown) is opened in the front surface of the second housing 3, and a sound emission port (second sound emission port) 16 for the information speaker 25 mentioned later is opened in the back surface of the second housing 3.

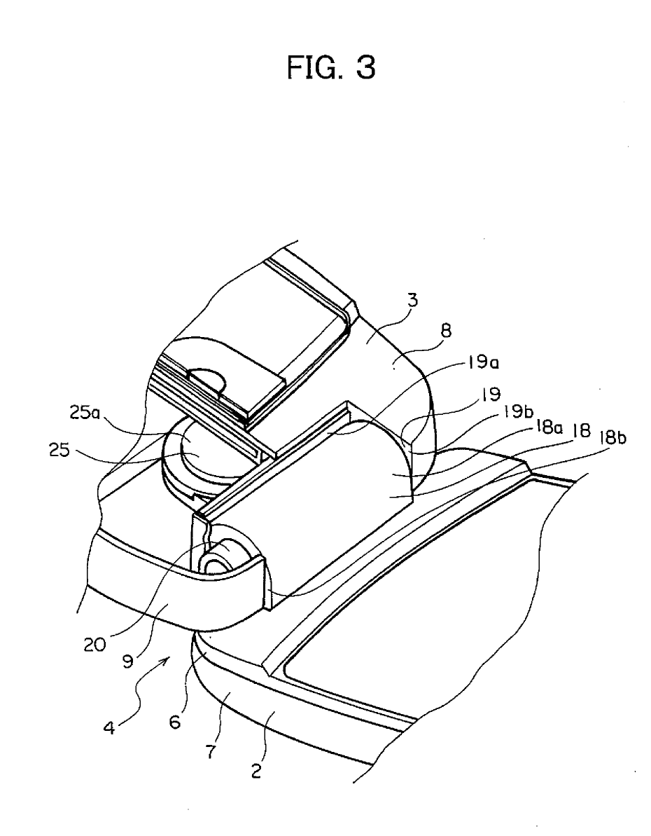

FIG. 3 is a partially cutaway perspective view showing a portion near the hinge part 4 of the mobile phone 1 in the opened state. The hinge part 4 is configured with a projecting part 18 projecting from one end of the first housing 2 being fitted in a recess 19 provided at one end of the second housing 3 and with a shaft member 20 inserted into the wall portion of the recess 19 and the projecting part 18. The shaft member 20 is supported pivotally by at least one of the wall portion of the recess 19 and the projecting part 18, so the first housing 2 and the second housing 3 can pivot with respect to each other about the shaft member 20.

The projecting part 18 is formed in a generally semi-cylindrical shape around the axis of rotation. There is a clearance between an outer circumferential surface 18a around the axis of rotation of the projecting part 18 and a wall surface 19a parallel to the axis of rotation of the recess 19, whereby rotation of the projecting part 18 with respect to the recess 19 is permitted. On the other hand, an end faces 18b of the projecting part 18 perpendicular to the axis of rotation touch against wall surfaces 19b of the recess 19 holding the projecting part 18 therein and slid with respect to the wall surfaces 19b of the recess 19 when the mobile phone 1 is open action or close action.

At the inside of the housing of the wall portion of the recess 19, the information speaker 25 is provided. The information speaker 25 emits an information sound when informing the user of an incoming call or informing the user of an erroneous operation. Further, the information speaker 25 is used in for various other purposes. For example, when utilizing a so-called “hands free” function allowing the user to converse without the mobile phone 1 brought close to the ear of the user, it functions as a speaker for outputting the voice of the other party. When utilizing a movie play function of the mobile phone 1, it functions as a speaker for outputting the audio played.

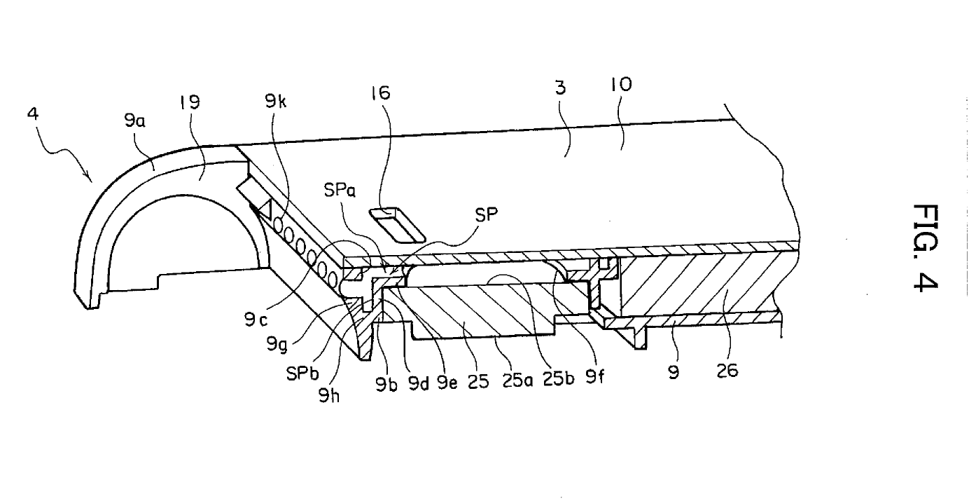

The information speaker 25 is formed in for example in approximately disk shape, has an electrode part 25a on one surface of the disk, and has a speaker surface 25b (see FIG. 4) on its other surface. It is arranged so that the speaker surface 25b becomes the back side of the second housing 3 (below sheet of FIG. 3). The information speaker 25 outputs audio by vibration of cone paper (vibration plate) arranged at the speaker surface 25b side in accordance with a current input to the electrode part 25a.

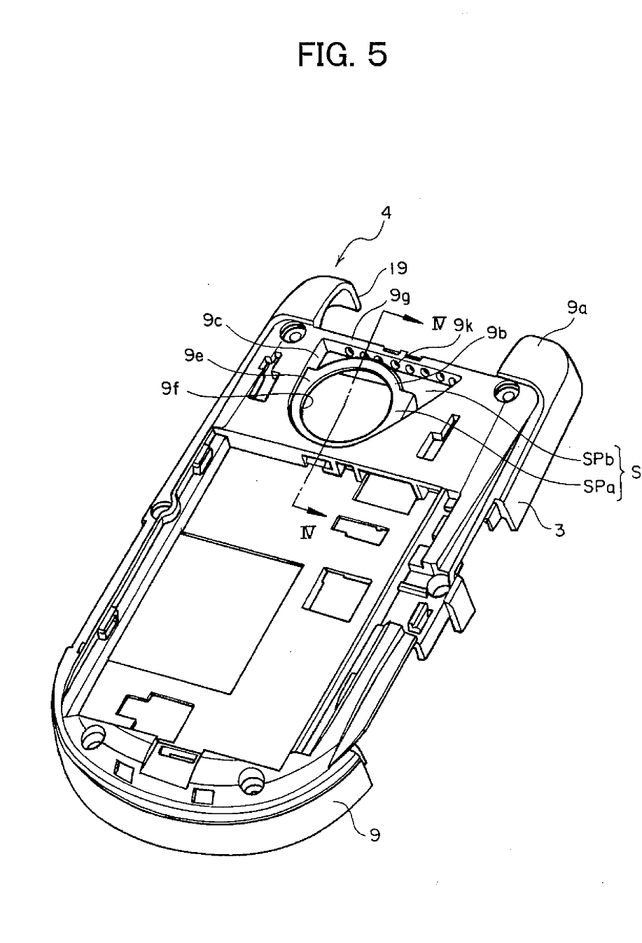

FIG. 4 is a sectional view showing a part of the second housing 3 (direction indicated by IV-IV arrow in FIG. 5). Note that the part above the sheet is the back side of the second housing 3. The information speaker 25 is arranged at the back case 9 at the inside of the housing (below sheet). On the back surface of the back case 9, a battery 26 forming the power supply of the mobile phone 1 is arranged. The information speaker 25 and the battery 26 are covered by the lid 10.

FIG. 5 is a perspective view of the back case 9 of the second housing 3 as seen from the back side of the second housing 3. The back case 9 is formed in a generally box shape with the side at the inside of the housing recessed. When combining the back case 9 and the front case 8, a space is formed between them. In the space, for example a not shown circuit board provided with a high frequency circuit etc. is arranged.

As shown in FIGS. 2A and 2B, the front case 8 and the back case 9 are formed with similar widths. The lid 10 is placed on the back case 9 and forms substantially the entire back surface of the second housing 3. Specifically, the lid 10 forms the range from the end on the opposite side to the hinge part 4 up to the recess 19 in the overall back surface. Only the back surfaces of the projecting parts 9a arranged at the both sides of the recess 19 are formed by the back case 9. Note that, as shown also in FIG. 5, the back case 9 is formed as if the back surface were cut away while leaving the projecting part 9a. When the lid 10 is placed over the back case 9, as shown in FIGS. 2A and 2B and FIG. 4, the back surface of the projecting part 9a and the back surface of the lid 10 become continuous.

As shown in FIG. 4 and FIG. 5, the back case 9 is provided with a holding part 9b for holding the information speaker 25. Specifically, part of the back case 9 at the recess 19 side is provided with a recess 9c recessed into the back surface. The holding part 9b is formed so as to project to the back side from the bottom of the recess 9c. The holding part 9b is formed in a cylindrical shape recessed into the back case 9 at the inside of the housing and has a wall 9d and an end face 9e. The end face 9e is formed to a circular frame shape with a circular opening 9f having a smaller diameter than the speaker surface 25b of the information speaker 25. The information speaker 25 is held by the holding part 9b by being inserted and fitted in the recess of the holding part 9b from the inside of the case and by its electrode part 25a side being restrained by the circuit board etc.

As shown in FIG. 4, the amount of projection of the holding part 9b is smaller in comparison with the depth of the recess 9c, so a clearance is formed between the end face 9e and the lid 10. Accordingly, at the periphery of the holding part 9b, a sound conduction space SP for conducting the sound output from the information speaker 25 and emitted from the opening 9f to the outside of the case is formed.

The sound conduction space SP has a first space SPa for conducting the sound from the opening 9f and a second space SPb for conducting the sound from the first space SPa. The first space SPa is defined by the lid (back plate) 10, the end face (first surface) 9e, and the wall of the recess 9c at the center side of the back surface. The second space SPb is defined by the lid 10, the wall 9d, a bottom (second surface) 9h of the recess 9c, and a wall 9g on the recess 19 side of the recess 9c. The second space SPb is larger in width (depth) from the lid 10 in comparison with the first space SPa by the amount of projection of the holding part 9b. A distance (first distance) W between the lid 10 and the end face 9e in the first space SPa is for example 1/10 to ½ of the thickness of the information speaker 25, for example, 1 mm. An amount V of projection of the holding part 9b is for example the same extent as the thickness of the information speaker 25, for example, 5 mm.

The first space SPa is communicated with the sound emission port 16 provided in the lid (back plate 10). Accordingly, the sound conducted by the first space SPa is emitted to the outside of the housing via the sound emission port 16.

The second space SPb is communicated with a plurality of sound emission ports 9k. The sound emission ports 9k are opened in the wall 9g of the recess 9c and aligned along for example the axis of rotation of the hinge part 4. The wall 9g is also the wall for forming the recess 19. The sound conducted by the second space SPb is emitted to the recess 19 via the sound emission ports 9k.

Note that, as shown in FIG. 5, the recess 9c is formed in an arc shape having the same diameter as that of the holding part 9b at the center side of the back case 9, and is formed so as to spread from the center side of the back surface to the recess 19 side. In other words, the shape of the second space SPb in the view from the lid 10 is formed so as to spread to the recess 19 side. Further, the sound emission ports 9k are arranged over substantially the same range as the diameter of the information speaker 25 or over a broader range than that. Accordingly, the sound of the information speaker 25 is efficiently emitted.

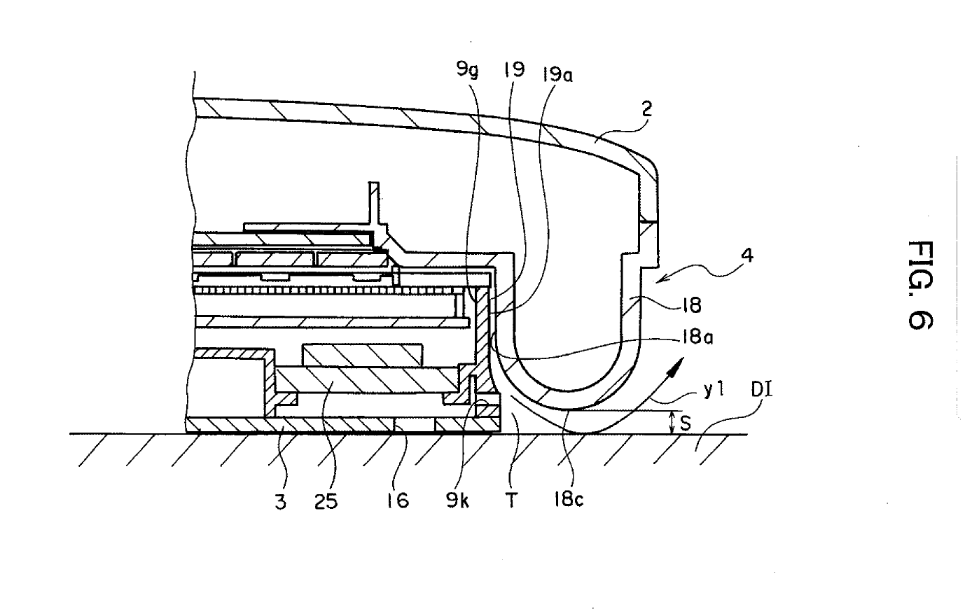

FIG. 6 is a sectional view showing a sound path of the information speaker 25 in the closed state. FIG. 6 shows a state where the second housing 3 is placed on a desk DI with the back surface down. The back surface of the second housing 3 is formed to a substantially flat shape and abuts against the surface of the desk DI. Accordingly, the sound emission port 16 is shut by the desk DI.

The projecting part 18 projects to the second housing 3 side from the surface facing the second housing 3 of the first housing 2. The top surface 18c thereof is located at the inside from the plane including the back surface of the second housing 3. Accordingly, there is a space S between the top surface 18c and the surface of the desk DI. Note that the plane including the back surface of the second housing 3 is a virtual plane including flat part of the back surface of the second housing 3. The flat part of the back surface may have a width large enough for the mobile phone to be stably placed on a desk etc. by the flat part. In FIG. 6, the surface of the desk DI coincides with the plane including the back surface.

Further, as mentioned above, there is a space between the outer circumference 18a of the projecting part 18 and the wall surface 19a of the recess 19, and the sound emission ports 9k are opened in the wall surface 19a. Accordingly, as indicated by an arrow y1, the sound output from the information speaker 25 passes through the sound emission ports 9k, the space between the projecting part 18 and the recess 19, and the space between the top surface 18c and the desk DI and is propagated outward.

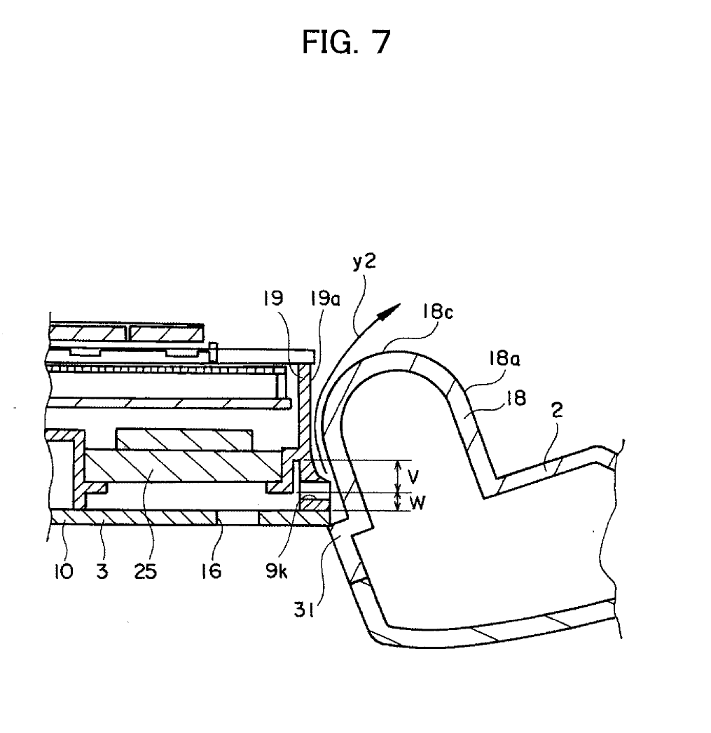

FIG. 7 is a sectional view showing the sound path of the information speaker 25 in the opened state. A stopper 31 for restricting the rotation of the first housing 2 with respect to the second housing 3 is formed in the base side of the projecting part 18. Specifically, the projecting part 18 is formed so as to project from a location slightly nearer the center than the end of the first housing 2. A corner formed by the end face of the first housing 2 and the front surface (surface above the sheet) functions as the stopper portion 31. Accordingly, the stopper 31 has a length over the recess 19 in the direction of the axis of rotation of the hinge part 4.

By the engagement of the stopper 31 with the end of the lid 10, the rotation of the first housing 2 is restricted. At this time, the space between the projecting part 18 and the recess 19 is shut at the back side by the stopper 31. On the other hand, the space is opened to the front side. Accordingly, as indicated by an arrow y2, the sound output from the information speaker 25 passes through the sound emission ports 9 and the space between the projecting part 18 and the recess 19 and emitted to the front surface of the housing.

Note that the projecting part 18 is formed as a semi-cylindrical shape, therefore the space between the projecting part 18 and the recess 19 flares out and the sound can be efficiently output outward.

According to the above embodiment, the top surface 18c of the projecting part 18 is located to the inside from the plane including the back surface of the second housing 3 in the closed state of the mobile phone 1, a space T is provided between the projecting part 18 and the recess 19, and sound emission ports 9k for emitting sound from the information speaker 25 are provided in the wall surface 19a of the recess 19 forming this space T. Therefore, even if placing the mobile phone 1 on a desk in the closed state with the back surface of the second housing 3 facing downward and the sound emission port 16 is blocked, the information sound can be emitted outward.

The second housing 3 is provided with the battery 16, substantially the entire back surface of the second housing 3 is formed by the lid 10 for the battery, and the sound emission port 16 is formed in the lid 10, therefore entry of moisture into the battery is reduced. Namely, conventionally, the sound emission port of the back surface (corresponding to the sound emission port 16) was formed in the back case, and the lid was placed over a range narrower than the entire back surface so as to avoid that sound emission port. Accordingly, a borderline between the lid and the back case was located on the back surface. It was considered that moisture entered from the back surface of the housing via the border line. However, in the present embodiment, as shown in FIG. 2B and FIG. 5, only the borderline of the based of the projecting parts 9a on the both sides of the recess 19 are located on the back surface and the borderline and the recess containing the battery 26 are partitioned, therefore entry of moisture from the back surface is suppressed.

The sound conduction space SP has the first space SPa and the second space SPb formed deeper from the lid 10 than the first space SPa, the sound emission ports 9k are communicated with the second space SPb, and the sound emission port 16 is communicated with the first space SPa, therefore the entry of moisture into the housing is reduced. Namely, the sound emission ports 9k are opened in the wall surface forming the recess 19, therefore the moisture entering from the sound emission ports 9k may enter from the opening 9f for the information speaker 25, but the first space SPa is formed shallower from the lid 10 than the second space SPb, therefore the moisture entering from the sound emission ports 9k stays in the second space SPb, so entry into the first space SPa is suppressed. Further, in the present embodiment, the first space SPa is located between the second space SPb and the battery, therefore the entry of moisture into the recess containing the battery 26 is also suppressed. On the other hand, the sound emission port 16 is opened in the back surface and communicated with the second space SPb, and the second space SPb is formed relatively shallow from the back plate. Therefore, the distance between the information speaker 25 and the sound emission port 16 becomes relatively short, thus sound can be efficiently emitted.

The information speaker 25 has the speaker surface 25b facing the lid 10 in the first space Spa, therefore the entry of moisture into the information speaker 25 is suppressed. Namely, the entry of moisture from the sound emission ports 9k into the first space SPa is suppressed as mentioned above, therefore the entry of moisture from the speaker surface 25b is suppressed. Note that the information speaker 25 is enough if the speaker surface 25b is exposed with respect to the sound conduction space, therefore the side surface of the information speaker 25 and the electrode portion side may be waterproofed by surrounding the information speaker 25 by the holding part 9b as in the present embodiment.

The stopper 31 for restricting further rotation to the opening direction by abutting against the back surface of the second housing 3 in the opened state is provided at the base side of the projection part 18, the space between the recess 19 and the projecting part 18 is opened on the facing surface side in the opened state of the mobile phone 1, and the back surface side is shut by the stopper 31, therefore the sound output by the information speaker 25 in the opened state can be efficiently emitted to the front side of the mobile phone 1. Due to this, for example, both when the information speaker 25 is utilized in the opened state at the time of a hands free function usage and the time of playing back a movie, the user can hear the sound output by the information speaker 25 more efficiently.

The present invention is not limited to the above embodiment and may be executed in various ways.

The mobile terminal of the present invention may be one having a first housing and second housing connected so that they can be opened and closed by a recess and a projecting part and having a speaker. The speaker may be any one informing the user of some information by outputting audio in the closed state. Accordingly, the mobile terminal is not limited to a mobile phone and may also be for example a laptop computer or PDA. The speaker is not limited to one informing the user of an incoming call or e-mail and may be for example one informing the user of the time or battery shortage. In other words, the mobile terminal need not have a communication function.

The sound of the speaker may also be output to the outside of the housing by only the first sound emission port without providing the second sound emission port. In this case, the sound emission port of the speaker can be made unnoticeable, so the design appearance is improved. On the other hand, when a second sound emission port is provided, the sound of the speaker can be more reliably output to the outside of the housing when the second sound emission port is not blocked, for example, when the mobile terminal is hung from somewhere. Note that since the sound can be emitted from the first sound emission port, it is possible to make the second sound emission port smaller in comparison with the conventional sound emission port on the back surface.

The mobile terminal of the present invention may be one put so that the second housing having the recess is placed on the first housing having the projecting part.

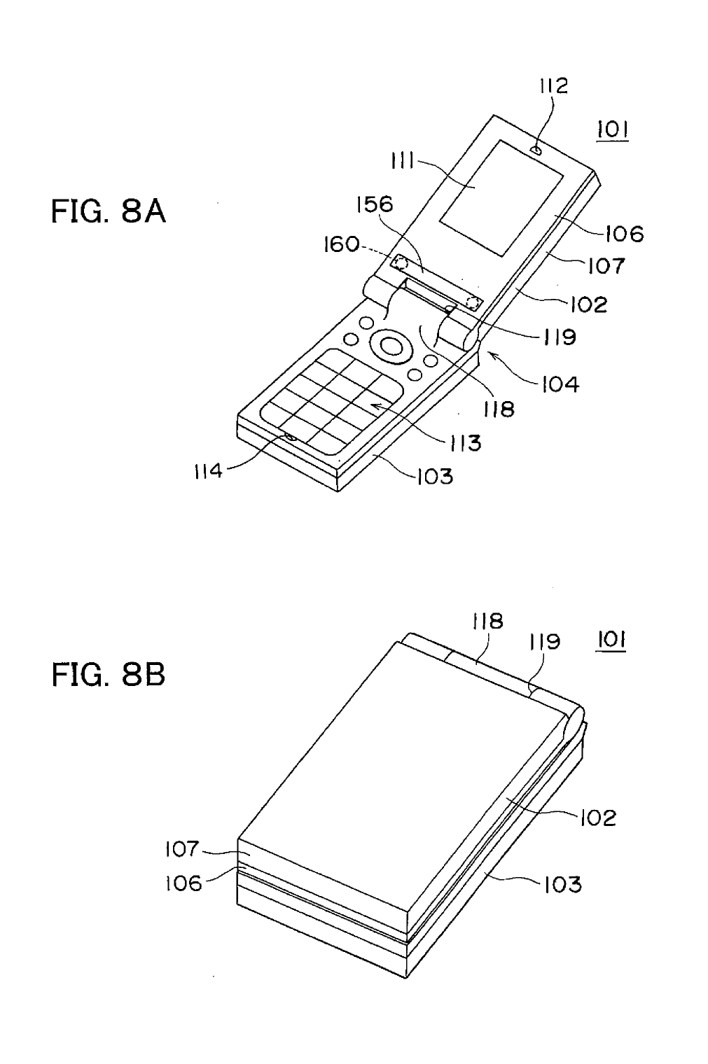

FIGS. 8 to 12 show a mobile phone 101 put so that the second housing 102 having the recess 119 is placed on the first housing 103 having the projecting part 118.

FIGS. 8A and 8B are perspective views of the appearance of a mobile phone 101, FIG. 8A shows an opened state and FIG. 8B shows a closed state.

The second housing 102 has a display 111 and a speech speaker 112 at a facing surface side. The first housing 103 has an input section 113 and a speech use microphone 114 at a facing surface side.

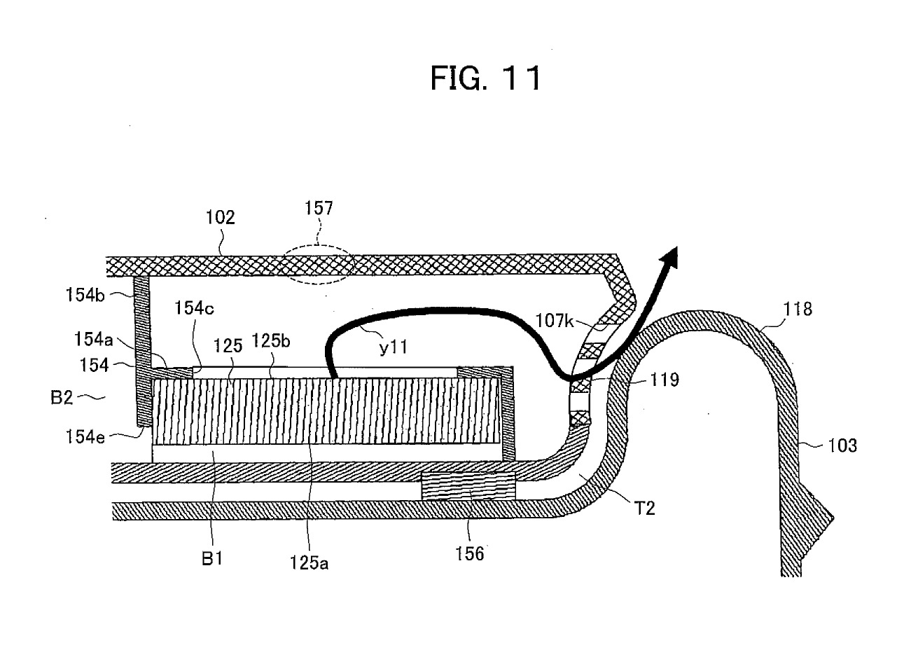

As shown in FIG. 8A, a screw cap 156 is provided on the facing surface of the second housing 102. The screw cap hides screws 160 fixing a front case 106 and a back case 107 of the second housing 102. The screw cap 156 is formed by for example the elasticity member such as rubber. The screw cap 156 is formed for example in the long shape extended along the rotation axis of hinge part 104, the length of the screw cap is set to for example more than width of the recess 119 and less than the width of the second housing 102. The screw cap 156 projects from the facing surface of the second housing 102 so as to touch the facing surface of the first housing 103 in the closed state (see FIG. 11). Note that, the screw cap 156 may be provided in the first housing 103, or both of the second housing 102 and the first housing 103.

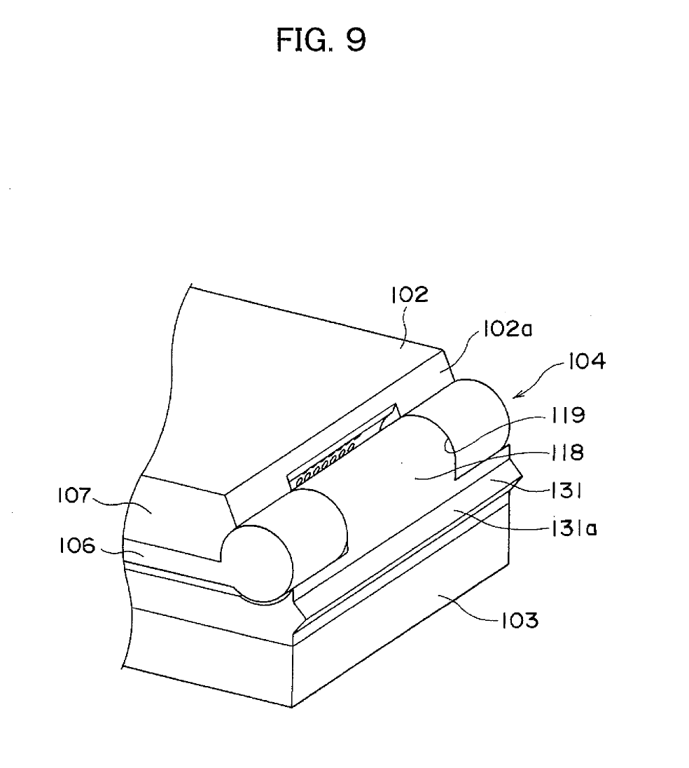

FIG. 9 is an enlarged view of hinge part 118. A projected rim 131 extended in the direction of the rotation axis of hinge part 104 is provided on end surface of the first housing 103 at the projecting part 118 side. The length of the projected rim 131 is same as the width of the first housing 103. In the opened state, a slope 131a of the projected rim 131 touch a slope 102a provided on the end of the second housing 102, so the rotation is restricted.

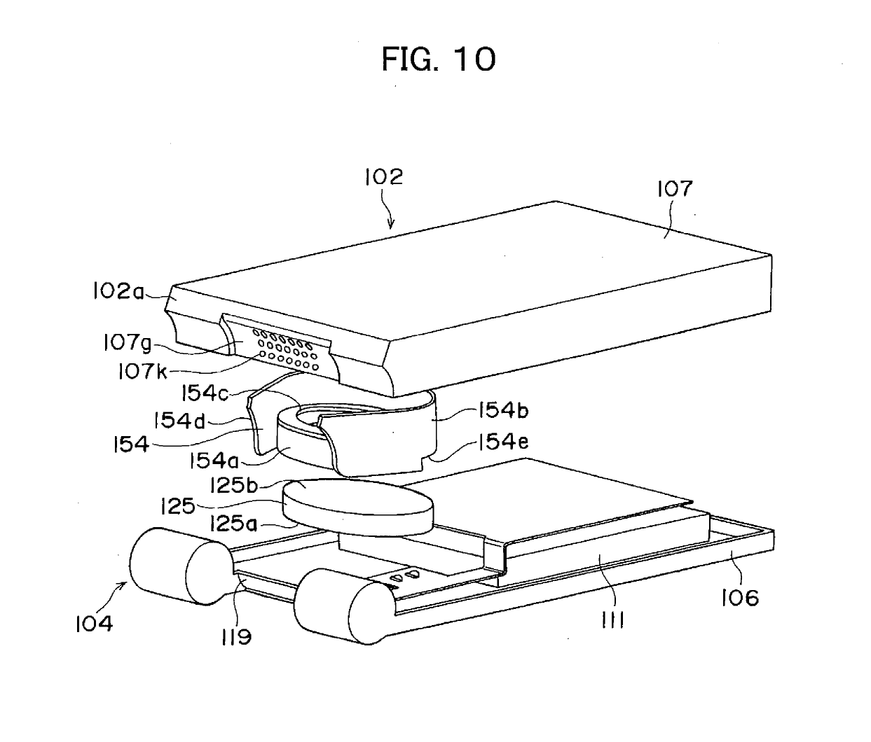

FIG. 10 is a disassembled perspective view of the second housing 102. A plural sound emission ports 107k are provided in the back case 107 at a wall portion 107g forming the recess 119.

An information speaker 125 is provided in the second housing 102 at the hinge part 104 side. The information speaker 125 is formed in for example in approximately disk shape, has an electrode part 125a on one surface of the disk, and has a speaker surface 125b on its other surface. The information speaker is arranged so that an electrode part 125a faces front case 106 and a speaker surface 125b faces back case 107.

The information speaker 125 is installed in the second housing 102 by a speaker holder 154. The speaker holder 154 has an inner portion 154a and an outer portion 154b.

The inner portion 154a is formed in approximately cylindrical shape where the thickness (height) thereof is same as it of the information speaker 125. The information speaker 125 is fitted into the inner portion 154a from facing case 106 side. An opening part 154c where the diameter thereof is smaller than it of the speaker surface 125b is provided in inner portion at the back case 107 side.

The outer portion 154b is formed in approximately plate shape enclosing the inner portion 154a. Note that, strictly, outer part 154b composes a portion of inner portion 111 in the display side (see FIG. 11). The outer portion is formed so as to be higher than the inner portion in the vertical direction of the FIG. 10, so the speaker holder 154 is fixed to the second housing 102 by placing the outer portion 154b between front case 106 and back case 107.

An empty part 154d is provided in the outer portion 154b at the hinge part 104 side. A cutting off portion 154e is provided in the outer portion at the opposite side to the hinge part 104 and at the front case 106 side.

FIG. 11 is a sectional view showing a sound path of the information speaker 125 in the closed state. FIG. 11 shows the state that the mobile phone 101 is put on for example a desk (not shown) so that the second housing 102 is placed on the first housing 103.

As indicated by an arrow y11, the sound output from the information speaker 125 passes through the opening part 154c, empty part 154d (see FIG. 10), sound emission ports 107k and a space T2 between the projecting part 118 and the recess 119 and is propagated outward (upward).

In this time, the space T2 is shut by screw cap 156 at connecting side to a space between the facing surfaces of the second housing 102 and the first housing 103, so it is prevented that the sound defuses into the space between the facing surfaces of the first housing 103 and second housing 102.

the information speaker 125 is holded by speaker holder 154 so as to form a space B1 between the information speaker 125 and the facing surface of the second housing 102. And the space B1 is connected to a space B2 provided in display 111 side of the speaker holder 154 through the cutting off portion 154e. Therefore, the back cavity of information speaker 125 is secured enough by the space B3 and the space B2, the pressure fluctuation in the back side of the vibration board of information speaker 125 is absorbed, and tone quality improves.

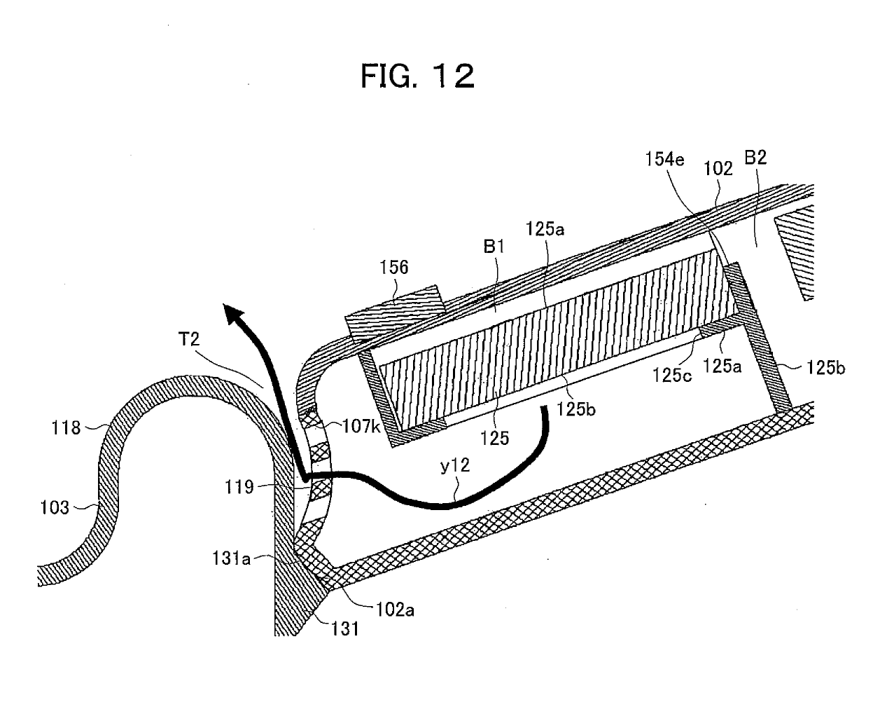

FIG. 12 is a sectional view showing the sound path of the information speaker 125 in the opened state. In the opened state, the slope 131a of the first housing 103 engages with the slope 102a of the second housing 102, so the rotation of the second housing 102 with respect to the first housing 103 is restricted. In this time, the space T2 between the projecting part 118 and recess 119 is shut by the projected rim at back side. On the other hand, the space T2 opens to front side. Therefore, as indicated by an arrow y12, the sound output from the information speaker 125 passes through the opening part 154c, empty part 154d (see FIG. 10), sound emission ports 107k and a space T2 between the projecting part 118 and the recess 119 and is propagated front side of the first housing 103 and the second housing 102.

Note that, a second emission port may be provided in the back surface of the second housing 102 at a position (an area 157 in FIG. 11) facing the information speaker 125. While the invention has been described with reference to specific embodiments chosen for purpose of illustration, it should be apparent that numerous modifications could be made thereto by those skilled in the art without departing from the basic concept and scope of the invention.

What we claim is:

1. A mobile terminal comprising:
a first housing having a projecting part on one end; and
a second housing having a recess in which said projecting part is fitted at one end and having a built-in speaker;
wherein said projecting part being pivotably connected in said recess so as to enable said first housing and said second housing to be opened and closed, a top surface of said projecting part is located at an inside from a plane including a back surface at an opposite side to a facing surface of said second housing in the closed state of the mobile terminal, there is a space between said projecting part and said recess, and a first sound emission port for emitting sound from said speaker is provided in a wall surface of the recess forming said space.

2. A mobile terminal as set forth in claim 1, wherein said back surface of said second housing is provided with a second sound emission port for emitting sound from said speaker.

3. A mobile terminal as set forth in claim 2, wherein said second housing is provided with a battery, substantially the entire back surface of said second housing is formed by a lid for said battery, and said second sound emission port is formed in said lid.

4. A mobile terminal as set forth in claim 2, wherein said second housing is provided with a sound conduction space for conducting the sound from said speaker to the first and second sound emission ports, the sound conduction space has a first space formed by a back plate forming said back surface of said second housing and a first surface separated from said back plate by a first distance and a second space formed by said back plate and a second surface separated from said back plate by a distance longer than said first distance, said first sound emission port is connected with said second space, and said second sound emission port is connected with said first space.

5. A mobile terminal as set forth in claim 4, wherein said speaker has a speaker surface facing said back plate in said first space.

6. A mobile terminal as set forth in claim 1, wherein a rotation limiter for restricting further rotation to an opening direction by engagement with the back surface of said second housing in the opened state is provided on said first housing at a base side of said projecting part, the space between said recess and said projecting part opens to said facing surface side and said back surface side is shut by said rotation limiter in the opened state of said mobile terminal.

7. A mobile terminal comprising:
a first housing having a projecting part on one end; and
a second housing having a recess in which said projecting part is fitted at one end and having a built-in speaker;
wherein said projecting part being pivotably connected in said recess so as to enable said first housing and said second housing to be opened and closed, there is a space between said projecting part and said recess, and a first sound emission port for emitting sound from said speaker is provided in a wall portion of said recess.

8. A mobile terminal as set forth in claim 7, wherein an opening part connected the space is provided at a top side of said projecting part in the closed state where said first housing and said second housing are superposed on each other, an opening part connected the space is provided at said top side of said projecting part side in the opened state where said first housing and said second housing do not face each other.

9. A mobile terminal as set forth in claim 8, wherein an external shape of said projecting part in a section perpendicular to an axis of rotation includes semicircle.

10. A mobile terminal as set forth in claim 7, wherein a second sound emission port for emitting sound from said speaker is provided in said second housing at a back surface opposite to a surface facing said first housing in the closed state where said first housing and said second housing are superposed on each other.

11. A mobile terminal as set forth in claim 10, wherein said second sound emission port faces a speaker surface of said speaker.

12. A mobile terminal as set forth in claim 7, further comprising a stopper provided on at least one of said first housing and said second housing, restricting rotation in the opened state by touching the other of said first housing and said second housing, and shutting a one end of said space.
